(19) United States
(12) Patent Application Publication
(10) Pub. No.: US 2015/0142483 A1
(43) Pub. Date: May 21, 2015

(54) METHOD AND SYSTEM FOR ELECTRONIC TICKET VALIDATION USING PROXIMITY DETECTION

(71) Applicant: Bytemark, Inc., New York, NY (US)

(72) Inventors: Micah Bergdale, New York, NY (US); Matthew Grasser, New York, NY (US); Nicholas Ihm, New York, NY (US); Gregory Valyer, Highland Park, IL (US)

(21) Appl. No.: 14/538,008

(22) Filed: Nov. 11, 2014

Related U.S. Application Data
(60) Provisional application No. 61/902,469, filed on Nov. 11, 2013.

(51) Int. Cl. G06Q 10/02; H04W 4/02; H04W 4/00

(52) U.S. Cl. CPC G06Q 10/02; H04W 4/008; H04W 4/021
USPC 705/5; 455/41.2

(57) ABSTRACT

This invention discloses a novel system and method for automated protocols between a mobile device and an electronic ticketing verification system, where proximity detection is used to automatically display the verification or to automatically control entry gates or turnstiles when the mobile device is verified has holding a valid ticket and being located in a specific location associated with the ticket.

### PRIORITY

This application incorporates by reference U.S. patent application Ser. No. 13/901,243, filed on May 23, 2013. This application claims priority to as a non-provisional continuation and incorporates by reference U.S. Provisional Patent Application No. 61/902,469 filed on Nov. 11, 2013.

### FIELD OF INVENTION

This invention provides a mechanism whereby a venue or other facility that meters usage by means of tickets can distribute tickets electronically and use a visual aid on an electronic device to visually confirm that a person is a valid ticket holder.

### BACKGROUND

Venues such as theaters, amusement parks and other facilities that use tickets, for example airlines, ferries and other transportation have a need to use electronic ticketing. Existing systems distribute information that can constitute a ticket, but the verification problem is difficult. In one example of prior art, an electronic ticket is displayed as a bar-code on the recipient's telephone display screen. The telephone is then placed on a scanner that reads the bar-code in order to verify the ticket. The problem with these systems is that the scanning process is fraught with error and the time taken to verify the electronic ticket far exceeds that of the old system: looking at the paper ticket and tearing it in half. Barcode scanners were not designed to read a lit LCD screen displaying a bar code. The reflectivity of the screen can defeat the scanning process. Therefore, there is a need for an electronic ticketing system that provides a human-perceivable visual display that the venue can rely on to verify the ticket. This invention provides for the distribution of an electronic ticket that also contains a visual display that ticket takers can rely on as verification, without using a scanning device.

### DESCRIPTION OF THE FIGURES

FIG. 1. Basic architecture.

FIG. 2. Flow chart for ticket purchase.

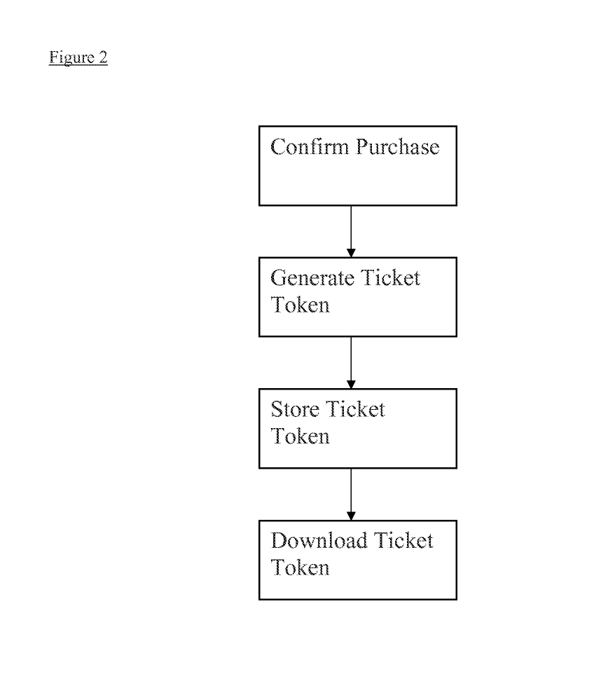

FIG. 3. Flow chart for displaying the verifying visual object.

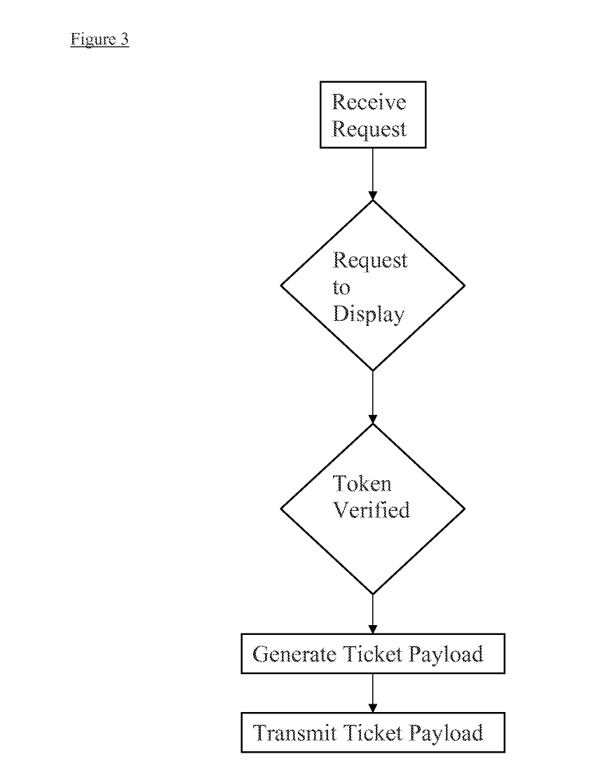

FIG. 4. Example validating visual object.

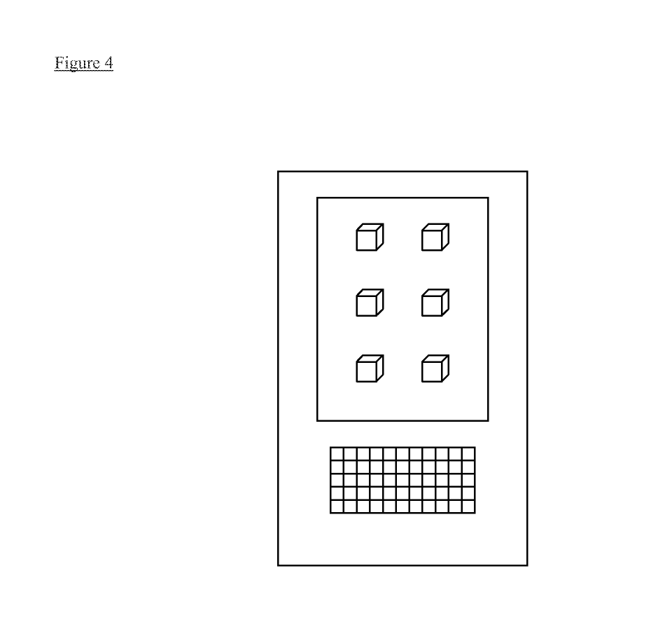

FIG. 5. Example validating visual object

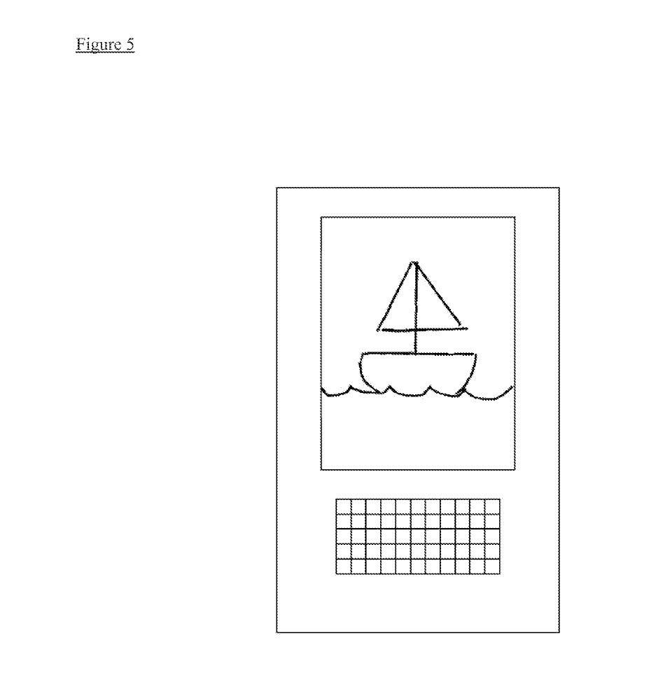

FIG. 6. Schematic of event database record.

FIG. 7. Schematic of authorized user database record.

FIG. 8. Flow chart for transfer of ticket.

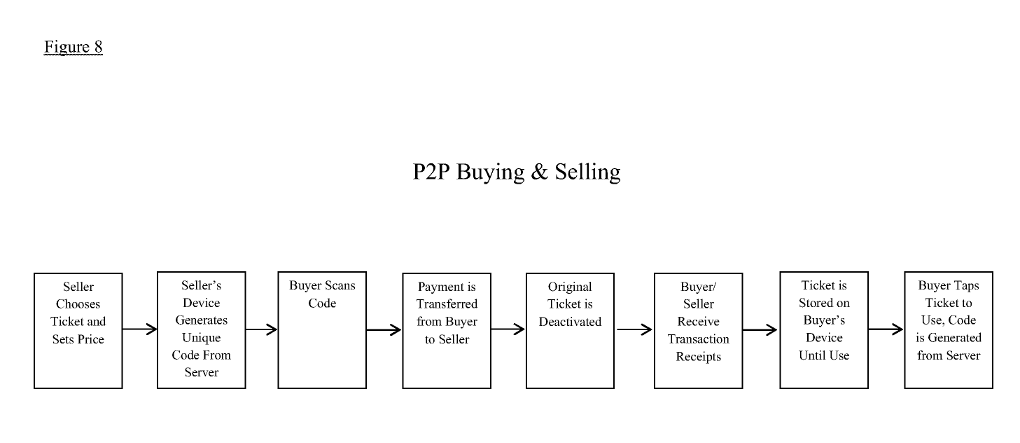

FIG. 9. Example user interface on user's device.

FIG. 10. Example user interface showing activation selection screen.

FIG. 11. Example user interface showing display of validating visual object and other ticketing information.

FIG. 12. Flowchart for ticket activation process.

FIG. 13a. Protocol diagram for activation process.

FIG. 13b. Continued protocol diagram for activation process.

FIG. 14. Flowchart for persistent channel.

FIG. 15. Flowchart for persistent channel for purchase verification.

FIG. 16. Example turnstile deployment.

FIG. 17. Example system architecture.

FIG. 18. Flowchart for proximity detection and validation.

FIG. 19. Flowchart for ticket issuance and validation

### DETAILED DESCRIPTION OF THE PREFERRED EMBODIMENTS

The system operates on one or more computers, typically one or more file servers connected to the Internet and also on a customer's computing device. A customer's device can be a personal computer, mobile phone, mobile handheld device like a Blackberry™ or iPhone™ or any other kind of computing device a user can use to send and receive data messages. The customer's device is used to display the validating visual object.

Conventional electronic tickets display a barcode or QR code on a user's telephone, typically a cellphone or other portable wireless device with a display screen. The problem with this approach is that a barcode scanner has to be used by the ticket taker. Barcode scanners are not highly compatible with LCD screen displays of barcodes. The amount of time that it takes to process an electronic ticket is greater than that of a paper ticket. Sometimes the LCD display does not scan at all and a passenger has to be sent away to get a paper printout of a ticket. Given the potential large crowds that often attend open venues, this is impractical.

In this invention, the ticket is procured electronically and stored on the user's device. However, when the ticket is to be taken the verification is determined by a larger visual object that a human can perceive without a machine scanning it. The particular validating visual object chosen can be constantly changed so that the ticket taker does not have to be concerned that a device displaying the designated validating visual object is invalid. There are many types of visual objects that can be displayed that are easily recognized by a ticket taker. These can include but are not limited to: Patterns of color change, Animations and Geometric patterns. In one embodiment, the validating visual object that is transmitted can be computer code, that when executed by the device, causes the user device to display the desired visual pattern. In another embodiment, the validating visual object is a command that specifies what the visual pattern should be. In that embodiment, the program operating on the user's device receives the command instruction, decodes it, and determines what visual patterns to generate based on the data in the command instruction. In another embodiment, the validating visual object is video or image data transmitted directly from the server to the device for immediate display.

In one embodiment of the invention, the user purchases a ticket from an on-line website. The website sends to the user's device a unique number, referred to as a token. The token is also stored in the ticketing database. When the time comes to present the ticket, the venue can select what visual indicator will be used as the designated validation visual object. The user can then request the validation visual object. The user's device will have an application that launches a user interface. The user can select “validate” or some other equivalent command to cause the application to fetch and download from the ticketing system a data object referred to herein as a ticket payload, which includes a program to run on the user's device. In another embodiment, the ticket payload can be pushed to the device by the venue. As a result, the application transmitted to the user's device is previously unknown to the user and not resident in the user's device. At that point the user's device can execute the program embodied in the ticket payload, which causes the validation visual object to be displayed on the user's device. The ticket taker knows what the validating visual object is, and simply looks to see that the user's device is displaying the correct visual object.

Piracy is limited in several ways. First, the ticket holder and their device does not have access to the validating visual object until a time select to be close to the point in time where the ticket has to be presented. Second, the validating visual object is one of a very large number of permutations and therefore cannot be guessed, selected or copied ahead of time. Third, the ticket payload can contain code that destroys the validating visual object in a pre-determined period of time after initial display or upon some pre-determined input event. Fourth, a number of security protocols can be utilized to ensure that a copy of the application that executes to display the validating visual object cannot be readily copied or reverse engineered.

### Validating Visual Object Displays:

There many kinds of validation displays that can be utilized. The criterion for what constitutes a validating visual object is one that is readily recognizable from human observation, is encapsulated in such a way as to be transmitted to the customer's device with a minimum of network latency or download time, and that can be reasonably secured so as to avoid piracy. Barcodes and similar codes like the QR code are not validating visual objects because a person looking at them cannot tell one apart from another. Instead, the person has to rely on a barcode scanner and computing device to verify the barcode.

In one embodiment, the period that a particular validating visual object may be used is automatically limited. Examples of validating visual objects include:

1. A color display on the device.
2. A color sequence.
3. An animation that is easily recognized.
4. Animations can include easily recognizable geometric patterns, for example an array of diamonds, or an array of rotating cubes.
5. A human recognizable image.
6. The customer's face as an image.
7. Combinations of the above.

In another embodiment, other images, for example, block letter, can be displayed so that additional information readily apparent to the ticket taker is displayed. For example, a letter can be designated for a Child ticket or a different letter for an Adult ticket. In this embodiment, the type of user may by a senior, child, military personnel, student, or some other pre-designated category of user with a special ticket or use privileges. As part of the ticket issuance process, there is a verification process to ensure that the ticketing type actually matches up with the ticket that should be allowed for that end user. If a ticket is purchased by a user and the ticket has a special attribute associated with the ticket, the data record associated with the user is updated to include the status. For example, the user data record can be updated to include a “SENIOR” flag. The user account is authenticated to allow for a certain type of discounted or other special ticketing. This can happen by means of submitting an ID string and the ID being validated to the registered user and the registered user device. Using whatever verification is appropriate results in the user data record being updated so that a logic flag or data value is indicated and associated with the ticketing type. The user account is associated with a specific mobile device. Following along the same process that is described below where a third party can manage a ticket and funds distribution to a mobile device, a mobile device can be locked to a user account for the purposes of receiving special ticket types, special deals, discounts, etc. that would only apply to that end user. The applicability of this could go much further too. By locking user devices to a user account and implementing a credential verification method, airlines could ensure that the mobile device being used for ticketing or club access or special discounts is the authorized user device for that user account and the ticket issued. Once the ticket has issued, determining the identity of the user would not be necessary because the validation of the ticket alone would indicate that it has to be that person who is bringing up the ticket since only a specific device could bring up a ticket for that user account. In other words, the security of the ticket is at the level of the security of the user account, in that the user is determined to hold the right to the special privileges and then this data is stored with their account. In one embodiment, the system uses a third party account and device management component. In another embodiment, the ticket issuer can directly manage the user account and associated device(s) for the purposes of allowing specialized ticketing, access, and discount solutions to the user by that ticket issuer. This helps prevent leakage from a person distributing out tickets, access, and discounts to the non-intended user and does not require the person processing the discount or checking the ticket to have to look at an actual ID. For example, if the visual object displays a notification that the ticket shows Military, the device itself has been authorized to allow that user to bring up a Military discounted ticket. Further, other embodiments include determining a security or privilege status for the mobile device as well as its components, for example, RAM, ROM, swappable parts like SIM cards, USB sticks, and other memory devices on which is stored security tokens and other secure data for the purpose of providing a secure platform, including memory integrated into the mobile device.

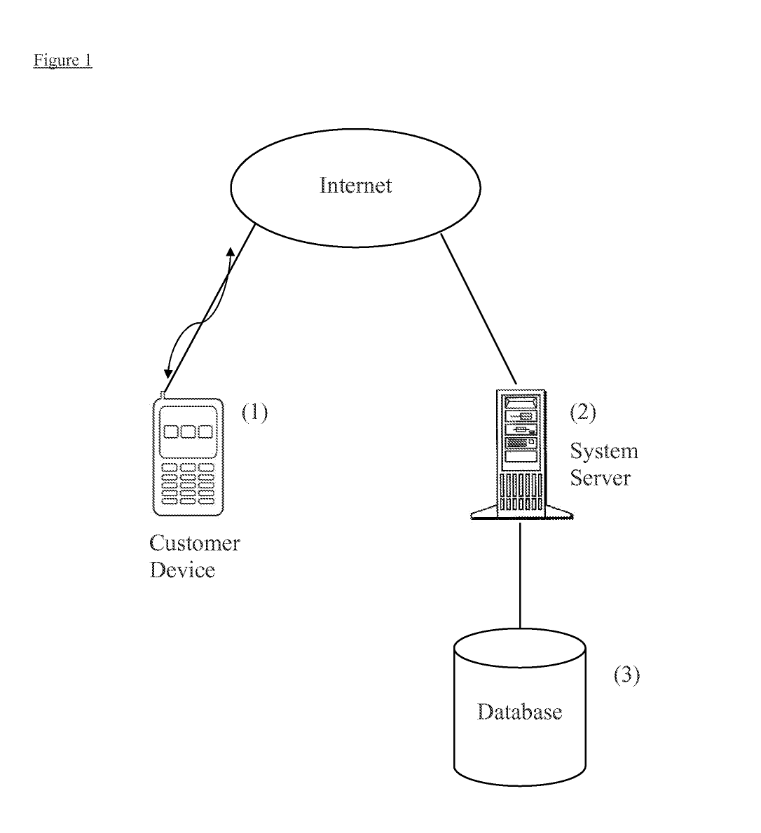

Referring now to FIG. 1, the customer uses their device (1) to purchase a ticket from the service operating the system server (2) and database (3).

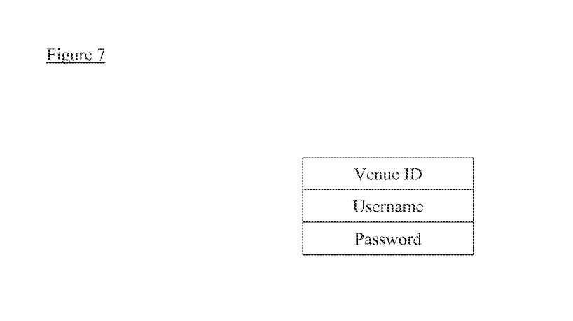

In one embodiment, an authorized user associated with the venue, typically the box office manager, logs into the back-end system through a secure web-page. The authorized user can enter the web-page by entering a username, password and venue identifier. The system maintains a database (3) that associates the venue identifier with a set of usernames and password pairs that are authorized to use the system on behalf of the venue. See FIG. 7. The system checks the database (3) to verify that the venue ID, username and password are consistent with each other. The authorized user can navigate through to a point in the system user interface where a particular show may be selected for ticket taking. The user selects the upcoming show, and then selects from a display of possible validating visual objects. The validating visual object is transmitted to a device viewable by ticket taking staff at the entrances to the venue. The staff then can see the authorized object to accept for the upcoming show.

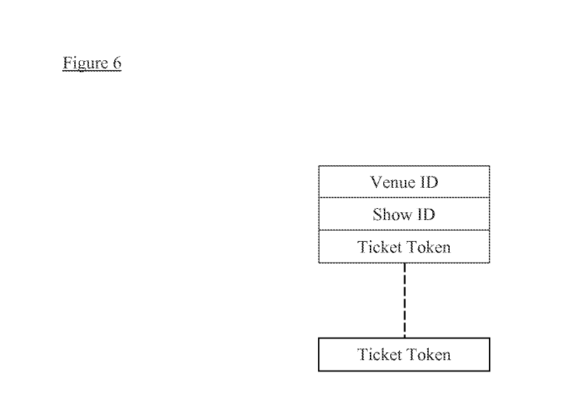

Ticket holders that have purchased tickets have a data record in the system database that contains the unique token associated with the ticket and other relevant information, including the venueID and an identifier identifying the specific show the ticket is for. See FIG. 6. At the entrance, customers are requested to operate an application on their devices. This application fetches the stored ticket token and transmits that token to the system, preferably over a secure data channel. The database looks up the token to check that the token is valid for the upcoming show. If the token is valid, then the system transmits back to the device a ticket payload. The ticket payload contains computer code that, when operated, displays the selected validating visual object.

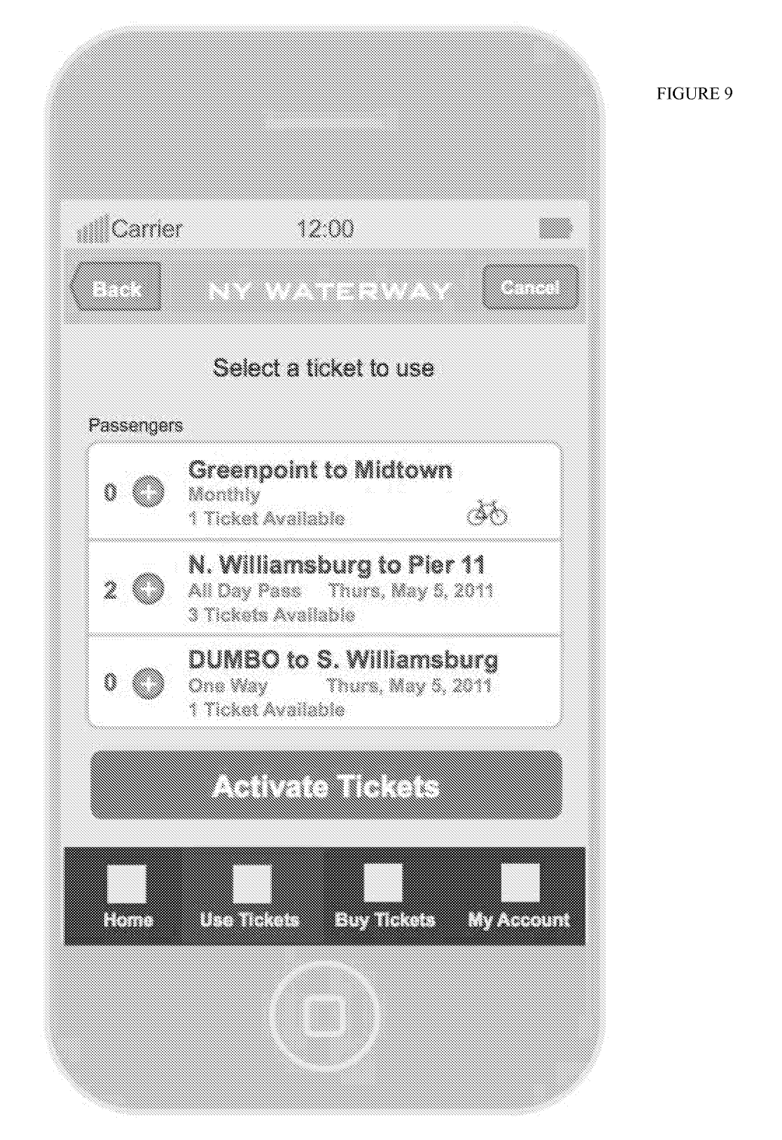

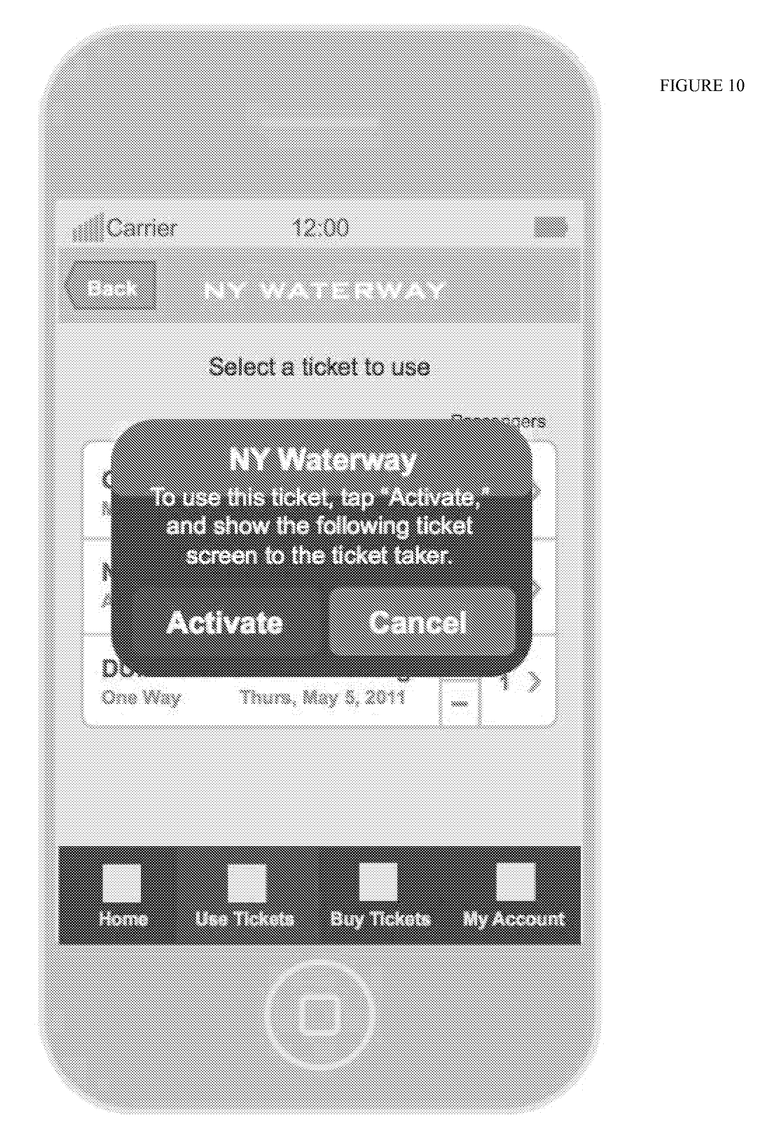

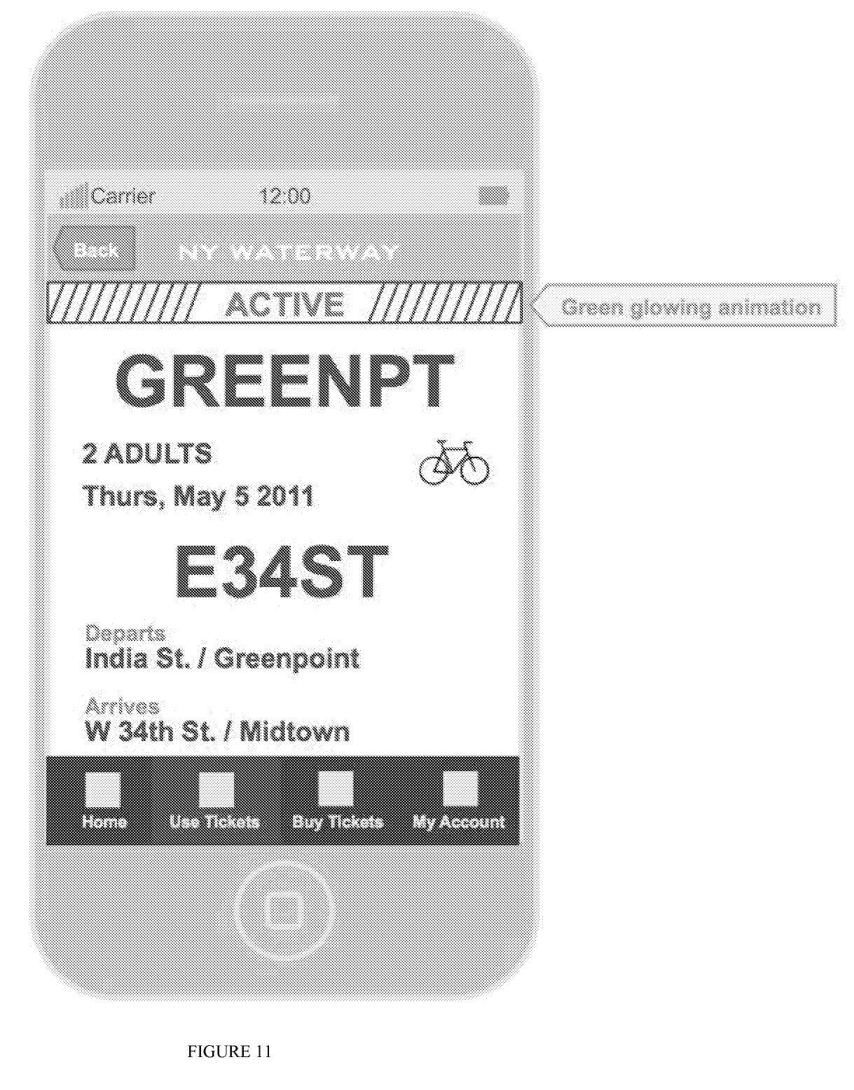

The customer can navigate the user interface of the application in order to cause the application to request whether to display the validating visual object. As shown in FIG. 9, one or more available tickets can be displayed on the user interface, which provides the user the ability to select one of the tickets. When the customer properly actuates the user interface, for example, by actuating the “Activate Tickets” button (see FIG. 10), the validating visual object is displayed on the screen of the device. The animation can be presented along with other ticketing information (see FIG. 11). In one embodiment, the device transmits the ticket token to the system with a command indicating that the ticket has been used. In another embodiment, the customer can operate the application and request that the application transmit to the database the condition that the ticket was used. In that embodiment, the user can input a numeric code or password that the application uses to verify that the customer is confirming use of the ticket. In yet another embodiment, after the validating visual object has been launched, a predetermined amount of time later it can be deemed used. At that time, the application can cause the color of the object to be changed so that it indicates that there was a valid ticket, but the ticket was used. This condition is useful in cases where the venue checks tickets during shows while letting customers move around the venue's facilities.

In another embodiment, the purchase of the ticket causes the ticket payload to be downloaded to the customer's device. Likewise, the authorized user for the venue will select a validating visual object for a particular show well in advance of the show. In this case, because a customer may possess the payload some time before its use, precautions must be taken to secure the ticket payload from being hacked so that any similar device can display the validating visual object. While this is a security tradeoff, the benefit is that the customer need not have an Internet connection at a time close to the showtime of the venue.

The use of electronic ticketing provides opportunities that change how tickets can be bought and sold. For example a first customer can purchase a ticket and receive on their device a ticket token. A second customer can purchase that ticket using the system. The first customer can use the application to send a message to the system server indicating that the first customer intends to the web-page indicating that it wants to buy that particular ticket. The system can ask the first customer for a username and password to be associated with the first customer's ticket. If the second customer identifies the first customer's username, the system then can match the two together. At that point, the data record associated with the first customer's ticket is modified so that the ticket token value is changed to a new value. That new ticket token value is then transmitted to the second customer's device. At the same time, the system can operate a typical on-line payment and credit system that secures payment from the second customer and credits the first customer. In one embodiment, the system pays the first customer a discounted amount, retaining the balance as a fee.

In yet another embodiment, the first customer may be unknown to the second customer. In that embodiment, the first customer simply may indicate to the system, through a message transmitted from the application operating on the device or directly through a web-page, that the first customer is not going to use the ticket and wishes to sell it. At that point, the system can mark the data record associated with the ticket as “available for sale.” When the second customer makes a request to purchase a ticket for the same show, the system creates a new ticket token for the second customer and updates the ticket token stored in the data record.

In a general admission type of scenario, the ticketing database is simple: each show has a venue ID, some identifier associated with the show itself, various time indicators, the selected validating visual object, and a list of valid ticket tokens. In a reserved seating arrangement, the ticketing database has a data record associated with a show, as indicated by a show identifier, but each seat has a data record that has a unique show identifier and ticket token, which includes the identity of the seat itself.

In the preferred embodiment, the validating visual object is secured against tampering. One threat model is that a customer who has received a ticket payload would then take the data file comprising the ticket payload and analyze it to detect the actual program code that when executed, produces the validating visual object on the display screen of the device. Once that has been accomplished, the would-be pirate can then re-package the code without any security mechanism and readily distribute it to other device owners, or even cross-compile it to execute on other types of display devices. The preferred embodiment addresses this threat model in a number of ways.

First, the ticket payload can be secured in a region of the device under the control of the telecommunications provider. In this case, the customer cannot access the code comprising the ticket payload. In another embodiment, the ticket payload can be encrypted in such a way that the only decrypting key available is in the secure portion of the telecommunications device. In that embodiment, the key is only delivered when an application running on the secure part of the device confirms that the ticket payload that is executing has not been tampered with, for example, by checking the checksum of its run-time image. At that point, the key can be delivered to the ticket payload process so that the validating visual object is displayed on the device.

Second, the selected animation is packaged for each device. That is, the code that operates to display the validating visual object itself operates certain security protocols. The phone transmits a ticket transaction request. The request includes a numeric value unique to the device, for example, an IMEI number. Other embodiments use the UDID or hardware serial number of the device instead of or in combination with the IMEI number. The system server then generates the ticket token using the IMEI number and transmits that value to that device. In addition, the ticket payload is created such that it expects to read the correct IMEI number. This is accomplished by the system server changing portions of the ticket payload so that the it is customized for each individual IMEI number associated with a ticket token. The animation code comprising the ticket payload is designed so that it has to obtain the correct IMEI number at run time. In another embodiment, at run-time, the animation code will read the particular ticket token specific for the phone that instance of the animation was transmitted to. The code will then decode the token and check that it reflects the correct IMEI number for that device.

In another embodiment, the security protocol first requires the user to login to the server with a login username and password. The application also transmits the IMEI, UDID or serial number of the device or any combination of them. When verified by the server, an authorization key (Authkey) is transmitted to the device. The Authkey is a random number. When the user's application transmits a request for a validating visual object, it transmits the Authkey and the IMEI, UDID or serial number (or combination) that is used for verification. This is checked by the server for validity in the database. On verification, the validating visual object is encrypted using the Authkey and transmitted to the device. The application running on the device then uses the Authkey to decrypt and display the validating visual object. The Authkey is a one-time key. It is used once for each ticket payload. If a user buys a second ticket from the system, a different, second Authkey is associated with that second ticket payload. In one embodiment, the Authkey is unique to the ticket for a given event. In another embodiment, the Authkey is unique to the ticket, device and the event. In other embodiments, the Authkey can be replaced with a key-pair in an assymetric encryption system. In that case, the validating visual object is encrypted with a “public” key, and then each user is issued a private key as the “Authkey” to be used to decrypt the object.

In yet another embodiment, the Authkey can be encrypted on the server and transmitted to the device in encrypted form. Only when the application is operating can the Authkey be decrypted with the appropriate key. In yet another embodiment, the application that displays the validating visual object can request a PIN number or some other login password from the user, such that if the device is lost, the tickets cannot be used by someone who finds the device.

In another embodiment, the application running on the device can fetch a dynamic script, meaning a piece of code that has instructions arranged in a different order for subsets of devices that request it. The ticket payload is then modified so as to have the same number of versions that are compatible with a corresponding variation in the dynamic script. As a result, it is difficult to reverse engineer the application because the application will be altered at run time and the ticket payload customized for that alteration. One embodiment of the dynamic script would be expressed in Java™ computer language and rendered using OpenView. The ticket payload can be an HTML file called using Ajax.

Security can also be enhanced by actively destroying the validating visual object so that it resides in the device for a limited time. In one embodiment, the ticket payload has a time to kill parameter that provides the application with a count-down time to destroy the validating visual object. In another embodiment, the validating visual object is displayed when the user holds down a literal or virtual button on the user interface of the device. When the button is released, the application destroys the validating visual object.

Security can also be enhanced by retaining as steganographic data embedded in the validating visual object, the IMEI, UDID, Serial number or phone number of the device. The application can be operated to recover that information and display it on the screen. This makes it possible for security personnel at a venue to view that information from a validly operating device. If the device is showing a pirated validating visual object, then the actual data associated with the device will not match and it will be apparent from inspection of the device. This way, suspicious ticket holders can be subject to increased scrutiny, the presence of which deters piracy.

In another embodiment, the ticket payload can operate a sound sampling application that requests the customer to speak in to the device. The application can then use that data to check whether the voice print of the speaker matches the expected voice print. In yet another embodiment, the device can take a picture of the customer's face, and then facial recognition code embedded in the ticket payload can operate to check whether the features of the face sufficiently match a pre-determined set of features, that is, of the customer's face at the time the ticket was purchased. In yet another embodiment, the verification can be supplemented by being sure that the use of the ticket is during a pre-determined period of time. In yet another embodiment, the verification can be supplemented by the ticket payload operating to check that the location of the venue where the ticket is being used is within a pre-determined range of tolerance to a GPS (Global Positioning System) location. In yet another embodiment, after a certain pre-determined number of downloads of ticket payloads for a specific show, the validating visual object is automatically changed. This last mechanism may be used for promotions, to select the first set of ticket buyers for special treatment at the venue. In yet another embodiment, two different validating visual objects may be used, which are selected based on the verified age of the customer. In this way, a venue can use the system to not only to verify ticket holders coming into the venue, but to verify their drinking age when alcoholic drinks are ordered.

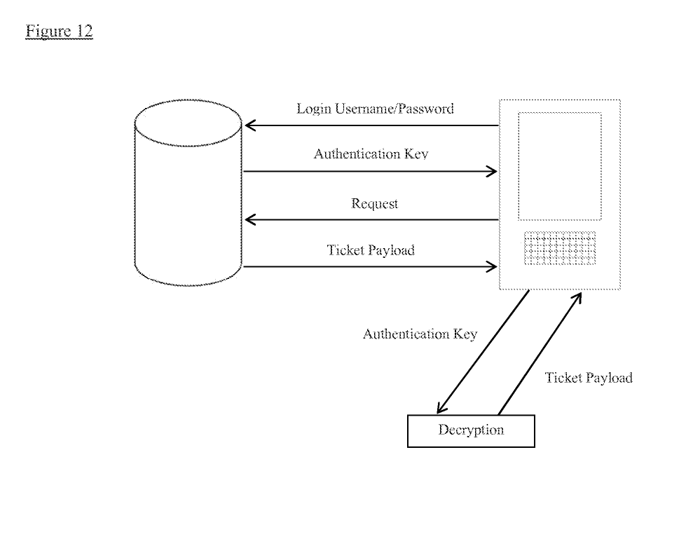

In yet another embodiment, the system's servers control the ticket activation process. FIG. 12. In this embodiment, the token is generated randomly by the user's mobile computing device and then transmitted to and stored on the system server as a result of the user's request to activate the ticket. When the server receives a request to activate a ticket, the server checks whether there is already an activation token stored in its database that corresponds to that ticket. The token is stored in a data record associated with the user that is activating the ticket. The user logs into the account and then requests that a ticket be activated. If it is, then it checks whether the token received from the user's mobile device matches the stored token. That is, it authenticates against that stored token. If the user's request for activation is the first activation of the ticket, then the server stores the received token into the data record associated with the user's account and keeps it there for a predetermined period of time, in order to lock the ticket to that device for that period of time. This process locks a ticket to that unique token for that lock period. Typically this will lock the ticket to the user's mobile computing device. If the stored token does not match the token received from the user's computing device, the ticket activation is denied.

The predetermined lock time permits a reusable ticket to be locked to a device for the predetermined lock time. This is useful in the event the user changes the mobile computing device that the user uses to the ticket. For example, a monthly train commuting ticket would be activated once each day, and would remain activated for the day of its activation. In this case, the user would validate the ticket once each day, and that activation would be locked to the device for the day. The next day, the user would be able to activate the ticket using a different mobile computing device if the predetermined time locking the activation has expired, that is, if the data record associated with the ticket has been automatically reset into a deactivated state. The activation process also permits a user account to be shared within a family, for instance, but that each ticket sold to that account to be locked to one device.

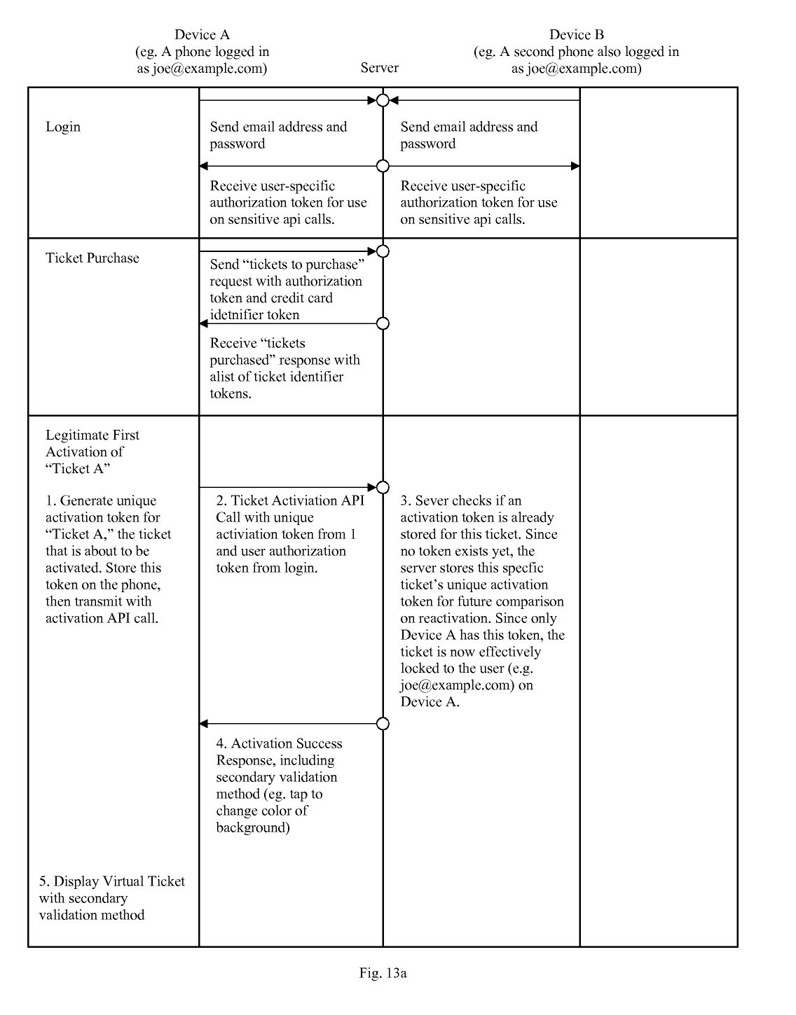

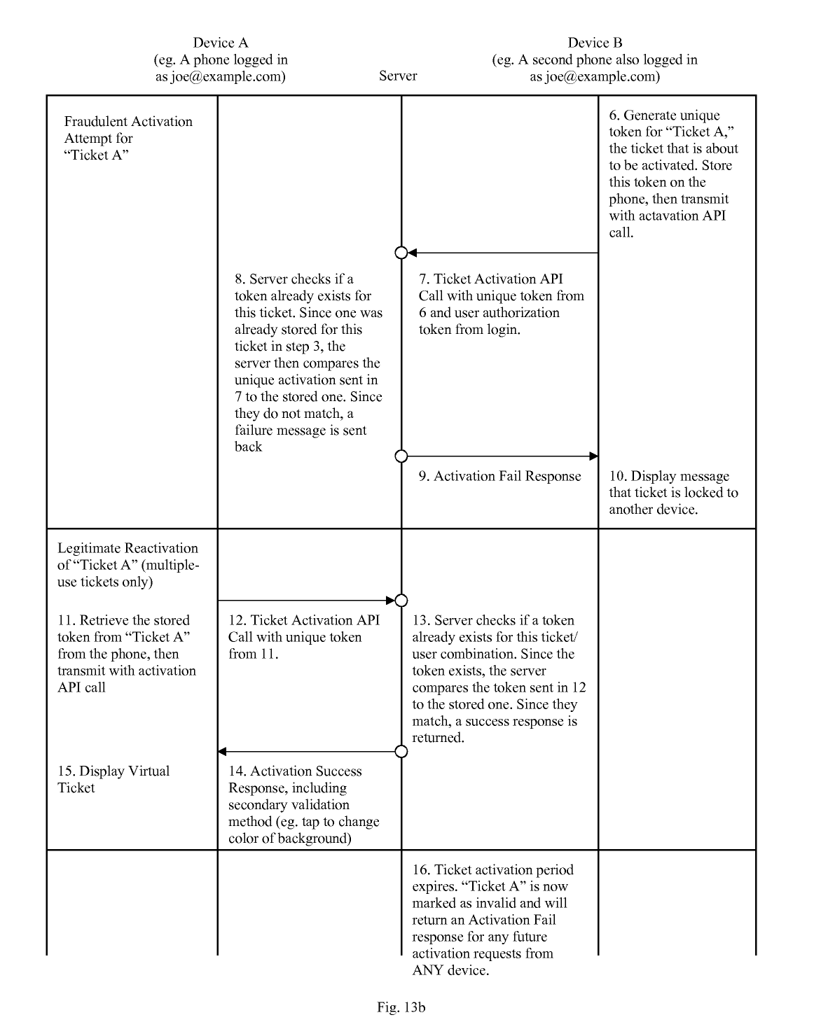

As depicted in the protocol diagrams FIGS. 13a and 13b, the user can use their mobile computing device to request that their ticket get activated for the first time. However, once that activation process has occurred, the server will store the unique token received from the activating user's computing device in the database in a manner that associates it with the ticket and the user's account. If another user associated with the account attempts to use the ticket by activating it, a different random token will be transmitted to the server. Because these two tokens do not match, the second activation will be prohibited.

Third Party User, Device, and Ticket/Funds Management. The ability of a third party to manage, distribute, remove, or authorize tickets, passes, funds, or entry for a specific user device and/or user account combination are aspects of additional embodiments. In one embodiment, there are currently tools for user mobile device management for the purposes of managing the software that resides on a phone. There is also account management software that is used to associate tickets, passes, and funds to a user's account. In yet another embodiment, there can be multi-factor management that provides specific controls over the user account and device management which are combined for the management of tickets, passes and funds. In this embodiment, the management system can permit an authorized third party to manage the association of a user account with a device, or a ticket with a device. For example, if an employee that has employer sponsored tickets downloaded to their mobile device decides to replace the device with a new device, the employer can log into the system, bring up the portion of the user's account associated with the employer and then update the data record associated with the user that are related to the employer so that the existing purchased tickets become authorized for the new mobile device, while deactivated for the old device, in to prevent the old device from being able to utilize ticketing functionality.

In this embodiment, there is a computer system comprised of a management account and a user account. The management account is accessible by the ticket issuer. There may be many management accounts, given that the ticketing system may issue tickets for more than one location. In other words, there may be a management account for a sport venue and a management account for a subway system. The user accounts are associated with the user and the user's mobile device. When the user buys a ticket from a ticket issuer, the ticket issuer is provided the privilege of viewing and modifying the ticket data associated with the user's ticket from that ticket issuer. As a result of a user having a subway ticket and a sports venue ticket in their account, both the subway system and the venue have limited control of the user account portions associated with their respective tickets. Similarly, an employer that buys subway tickets for their employees may have limited control over the user's account portion associated with those purchased subway tickets. In other uses, the ticketing issuer can manage the transfer or sale of tickets from one user to another. In this scenario, the ticketing issuer has the authority to enter the management database and delete the ticket from the account of the transferor and input it into the account of the transferee. The transferee's device information is part of its account, so the new ticket is issued in accordance with the system requirements to bind that new ticket to the transferee's device.

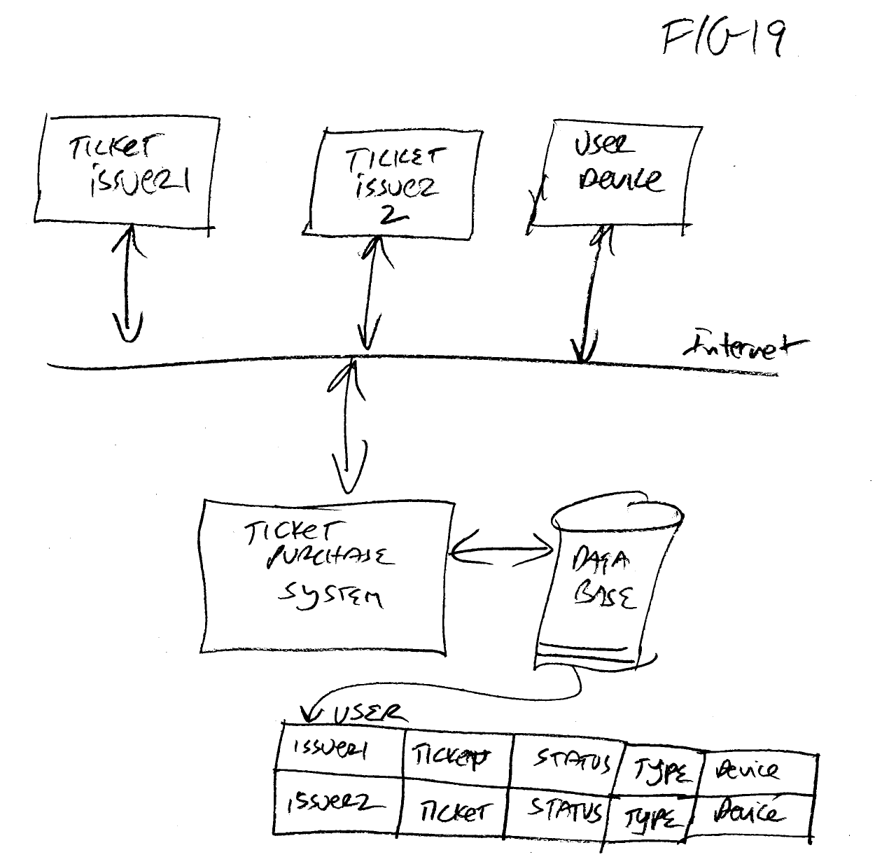

Referring to FIG. 19, the two ticket issuing entities have computer systems that are operatively connected to the ticket management system. That system is comprised of a database, which is further comprised of a data record associated with the user. The user may any number of tickets, but each ticket is associated with an issuer. A given ticket issuing entity can log into the ticket purchasing system and view all of the tickets it has issued or a subset based on a query, for example, all tickets for a particular event, or issued to a particular user or device. The ticket issuer is authorized by the ticket management system to only have the authority to view its own tickets and specific information related to the ticket. The system will shield the user's other ticket data or private information from the ticket issuer as appropriate. When the ticket issuer has finished modifying or managing the ticket entry, the ticket may then be issued to the user's device. Practitioners of ordinary skill will recognize that the embodiments of the database data records presented as a flat database file may also be equivalently expressed as a series of relational tables.

The activation process can also permit a ticket to be shared. In this embodiment, the user who has activated the ticket can submit to the server a request that the ticket be transferred to another user. For example, a data message can be transmitted from the user's device to the system that embodies a request to move the ticket to another user. In that case, the stored token is marked as blocked, or is equivalently considered not present. This is accomplished by storing a data flag in the database that corresponds to the ticket. One logic state encodes normal use and the opposite logic state encodes that the ticket has been shared. A data message may be transmitted to the second user indicating that the ticket is available for activation. The second user may submit a request to activate the ticket and a random token value is transmitted from the second user's device to the server. That second token value is checked to see if it's the first activation. Because the first user has activated the ticket, but then transferred it, the activation by the second user is not blocked. That is, the server detects that the first token is now cancelled or equivalently, the system has returned to the state where the first activation has not occurred and therefore permits the new activation to take place. The new activation can also have a predetermined time to live value stored in the database that is associated with it. In this case, the activation by the second user expires and the second user can be prevented from reactivating the ticket. At the same time, the flag setting that disables the first token can be reset, thereby setting the ticket up for reactivation by the first user. By this mechanism, it is possible for the electronic ticket to be lent from one user to another.

In yet another embodiment, the ticket activation process can open a persistent connection channel over the data network that links the server and the user's mobile computing device. In this embodiment, if the activation of the ticket and therefore the device is successful, the server can maintain a persistent data channel with a computer process running on the user's computing device. In this embodiment, the request for ticket activation causes the user computer device to open the persistent channel. In this embodiment, the server establishes a communication process operating on the server that receives data and then causes that data to be automatically routed to the user's computing device. The process on the user's mobile computing device can thereby automatically respond to that received data. In tandem, the computer process operating on the users computing device can send data directly to the server process associated with that user's session. For a server servicing many user devices, there will be one persistent channel established between the server and each mobile device that has an activated ticket.

The persistent channel between the server and the user's computer device can be used in a variety of ways. In the preferred embodiment, the persistent connection is designed so that that it maintains a bi-directional, full-duplex communications channel over a single TCP connection. The protocol provides a standardized way for the server to send content to the process operating on the user's computing device without being solicited by the user's device each time for that information, and allowing for messages to be passed back and forth while keeping the connection open. In this way a two-way (bi-direction) ongoing interaction can take place between a process operating on the user's computing device the server. By means of the persistent channel, the server can control the activity of the user computer device. For each user computing device, there can be a distinct persistent connection.

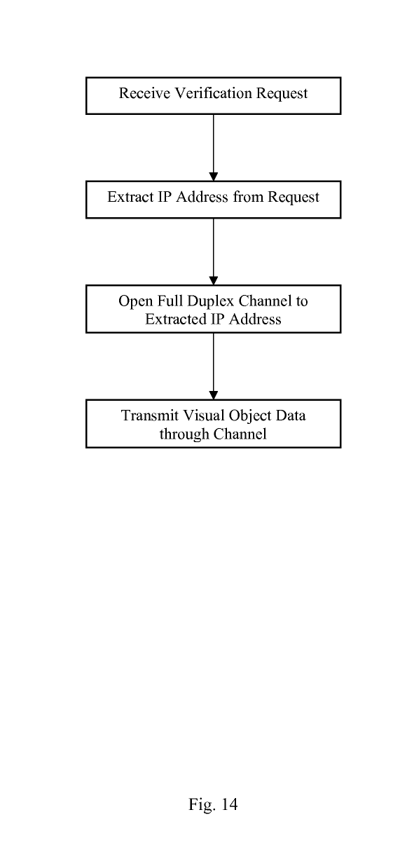

In one embodiment, the persistent connection is established when the user requests an activation of a ticket. See FIG. 14. In other embodiments, it can be used if the system is used to verify payment of a purchase price. In either case, the user computing device transmits a request message to the server. For each user computing device, there can be a distinct persistent channel. Each persistent channel has a label or channel name that can be used by the server to address the channel. In the case of ticketing, when the ticket is activated the data representing the validating visual object can be transmitted in real time from the server to the user computing device and immediately displayed on the device. This provides an additional method of securing the visual ticketing process. In this case, when the ticket is activated and the persistent channel is created, the label of the channel is stored in the database in a data record associated with the user and the ticket. When the server transmits the validating visual object for that ticket, it fetches from the database the label of the channel and then uses that label to route the transmission of the validating visual object. The use of the persistent channel causes the user computer device to immediately and automatically act on the validating visual object. In one embodiment, the receipt of the validating visual object causes the receiving process to immediately in response interpret the command and select and display the required visual pattern. In another embodiment, the process receives a block of code that the process calls on to execute, and that code causes the visual pattern to be displayed. In yet another embodiment, the process receives image or video data and the process passes that data on to the user device screen display functions for presentation on the user device screen.

In another embodiment, a validating visual object can be transmitted to the user's computing device to be automatically displayed on the screen without the user having to input a command to cause the display. That visual object can be displayed by the user computing device. For additional security, the server can transmit to the user computing device a visual object that contains the channel name or a unique number that the server can map to the channel name. For clarity, this additional visual object is not necessarily used for visual verification by ticket takers, as explained above. This visual object can be used by other machinery to confirm the ticket purchase transaction or even other transactions not directly related to the purchase of the ticket. The additional visual object can be in the form of a QR code, barcode or any other visual object that can be scanned, for example at a point of sale system, and from that scanned image, an embedded data payload extracted. In that visual object, data can be embedded that uniquely identifies the source of the scanned object. The channel name of the persistent channel or a number uniquely mapped on the server to identify the channel can be embedded in that scanned object.

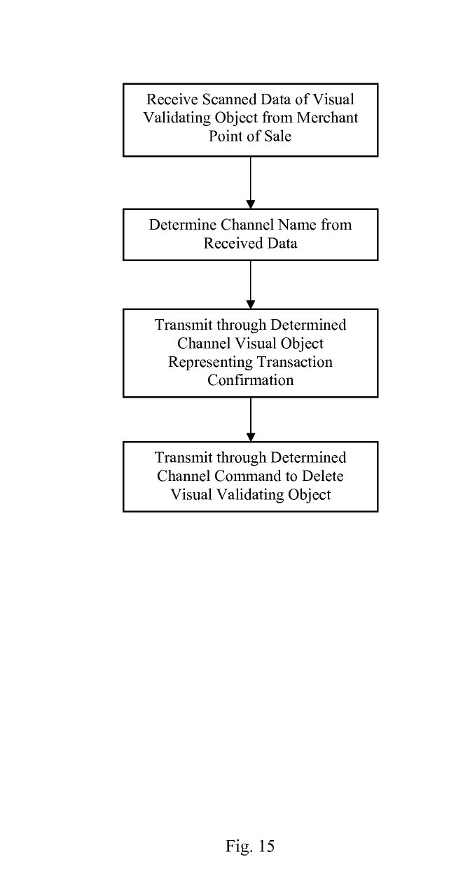

In one embodiment, as shown on FIG. 15, a merchant can use a point of sale system operated by the merchant to scan the display screen of the user's computing device. That point of sale system can then capture from the scanned image the channel name or a unique number that is uniquely mapped on the server to the channel name. That information is transmitted to the server as a challenge for verification. The received challenge data is checked to see if it matches the channel name or corresponding unique number used to transmit the visual object that the merchant scanned. If they match up, there is a verification of a transaction. This exchange provides verification that the user's device is present at the merchant location and that a transaction with the merchant should be paid for.

In yet another embodiment, the persistent connection provides a means for the server to control the actions of the process operating on the user's computer device that is at the other end of the connection. In this embodiment, the server can automatically transmit a command to the process on the user's computing device that automatically deletes the verifying visual object that has been transmitted to ensure that it cannot be reused or copied.

In one embodiment, the persistent connection is used to automatically transmit visual information to the user's mobile computing device and to cause that information to be displayed on the screen of the device. The visual information can be the validating visual object or any other visual object that the server selects to transmit for display. In this embodiment, the persistent connection can be used by the server to transmit other information to the user's device. In this embodiment, the server transmits text, images, video or sound and in some cases in combination with other HTML data. In another embodiment, this material comprises advertising that the server selects to display on the user's device. The selection process can utilize the GPS feature described above to determine the approximate location of the user's device and then based on that location, select advertising appropriate to be transmitted to that device. In yet another embodiment, the server selects the advertising content by determining predetermined features of the validated ticket or purchasing transaction and then making a selection on the basis of those features. For example, a validation of a ticket to a baseball game played by a team specified in the data associated with the validated ticket may cause the selection of an offer to purchase a ticket for the next baseball game of the same team. In yet another embodiment, the character of the transaction being verified can be used to cause the selection of advertising or the transmission of data comprising a discount offer related to the transaction.

In this embodiment, the server receives from the merchant the data that determines the persistent channel. The merchant, by relying on the system for payment will also transmit transaction details, for example, an amount of money and an identity of goods or services. When the channel name or unique number associated with the channel is matched for verification, the server can transmit data representing a confirmation display down to the user's device using the persistent connection. This data is received by the user computing device and then automatically rendered by the process at the other end of the channel connection. In addition, the server can use the transaction information to determine one or more advertisements or discount offers to transmit to the user's computing device. The selection method can consist of one or more heuristics. In one example, the validation of the ticket for a baseball game can trigger the display of advertising for food or drinks. Likewise, a transaction for purchasing a cup of coffee can trigger an advertisement for purchasing a newspaper.

### Proximity Detection for Entry Validation

In another embodiment, the invention is directed to a system that determines ticket validity based on a proximity analysis algorithm that the mobile phone on the consumer has a valid pass for entry into a venue, event or mode of transport, and that the person has a valid entry pass to go through the turnstile or other entry port mechanism. This process occurs without the need to present the cell phone and without the need for the mobile device owner to do anything at the point of entry other than to have the device turned on with Bluetooth LE turned on. The key here is the differentiation of enhanced proximity awareness along with user/account/device validation communications that occurs around the use of mobile electronic ticketing processes for entry or exit.

The system is comprised of two or more bluetooth le or other wireless proximity sensors, e.g. antennas, used to determine shared proximity. Shared proximity means that the data from all the sensors indicates that the same mobile device is present at a pre-determined location relative to the predetermined locations of the sensors, for example, the center of the turnstile. The detection data from the proximity detecting antennas is transmitted to a computer that uses the data to determine the exact location of the mobile device. This works similar to triangulation, but the amount of sensors is not necessarily limited to three sensors. By placing proximity sensors at and around a turnstile, a user can be validated as a legitimate pass/ticket holder without the need to scan a piece of paper or present the phone to a ticket taker or barcode reading device.

The algorithm requires the sensors to communicate with one another either locally or communicate with a server to determine whether the ticket holder meets the required criteria for a valid pass holder. The multiple sensors allow for ticketed passengers to enter into a virtual box to determine exact perimeters and centralization of the phone to make sure the person with the valid pass/ticket is the actual person about to enter the gate. Different ways of calculating or determining location may be used. In one case, the sensors determine approximate distance of the same mobile device. Geometric calculations based on the predetermined location of the sensors will result in the location of the mobile device. In another embodiment, the sensor sensitivity profile may have a shape that results in a signal of a certain set of strengths at all corresponding sensors that only occurs when the mobile device is at a predetermined location relative to the sensors. A third methodology is to combine location detection methods. For example, a light beam or ultrasonic sensor may be tripped to indicate that a person is within the box. At that instant, the sensor may be only one antenna with such a low sensitivity that it only captures the signal from a device located in the box. The system then determines that the mobile device so detected is the one in the box.

As a further iteration of this concept, the phone as part of the validation process can determine whether the device has more than one valid ticket associated with it and allow for multiple entries if there are multiple tickets available and set for use on the mobile device.

In another embodiment, Bluetooth LE, wireless proximity analysis, GPS and geo-fencing are used as a form of secondary validation for entry verification. The primary validation methods can include human-based visual validation of a ticket or pass, automated license plate reading, fingerprint scanning, facial recognition, or a unique alphanumeric ID entry via a keyboard or numeric keypad (telephone number generally) as the means of primary ID and the cell phone via Bluetooth LE, wireless proximity analysis, GPS or geofencing validates the individual and the account for the purposes of entry. This can be for toll roads, turnstiles, building security, gym memberships and other venue entry.

For the purposes of parking, in-car payment verification, restaurant payment validation and ticket validation, a phone using wireless token/key exchange to indicate a successful payment has been completed or that a valid ticket has been activated. This token exchange can occur via NFC, Bluetooth, WiFi or any other radio frequency transmission integrated into the light system. If a valid payment or ticket activation has occurred on the mobile device, the user will be issued a key/token that will allow them to turn a light on at the seat, car or table or indicate on another device display that the validation has occurred (or alternatively, has not occurred). For example:

If a person uses a cellphone to pay for a bill at a restaurant, the device receives a key that allows person to activate a light at the table. The light could be green (could be any color) to indicate a valid payment has been completed.

Another example is that a person sitting on a train or other transit can use the local ticket verification to actuate a light embedded into the seat in front. The person is able to activate the light using the encrypted key transmitted to the phone, which is then locally transmitted to a device controlling the light. When the ticket taker walks through the train car, he does not need to stop at the seats where there is an active light because that ticket holder has already been activated.

The invention can also be applied to visually impaired persons. A person who is visually impaired would have the capability to get onto a bus, train, or boat and they would receive a vibration or noise on their mobile device to indicate that their ticket has been validated and that they have valid entry. A similar concept can be added for handicap access into transit systems where there are special service doors for disabled passengers to enter and exit a transit system.

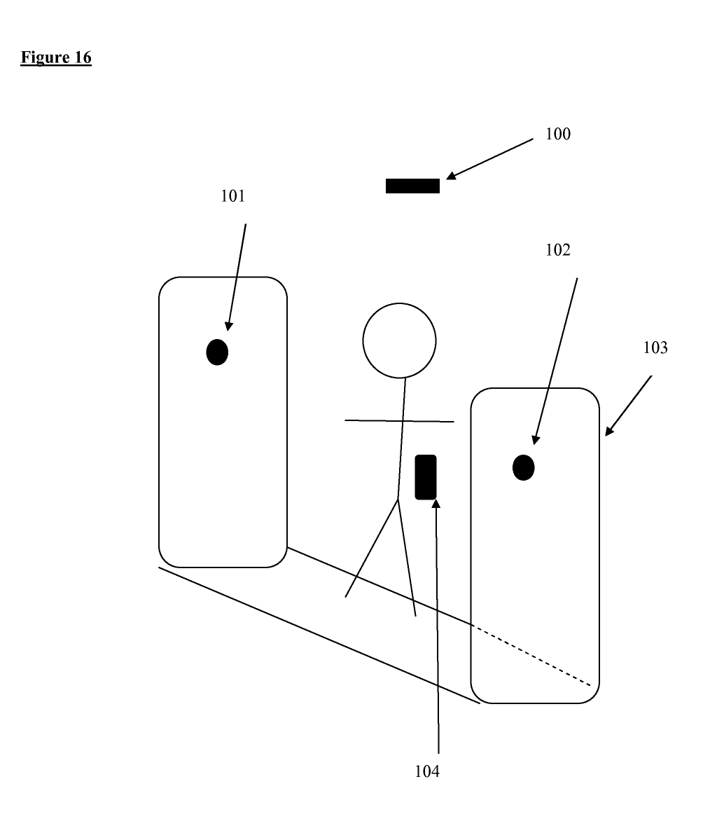

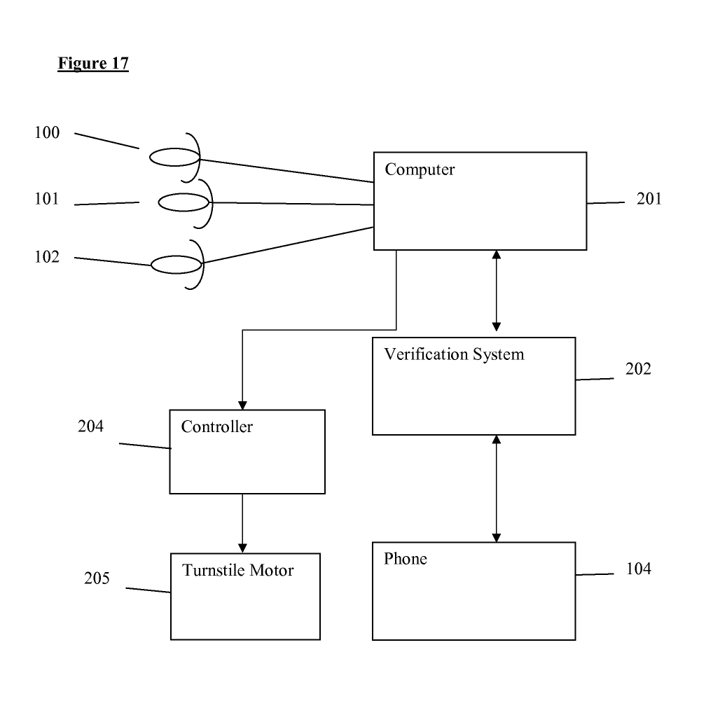

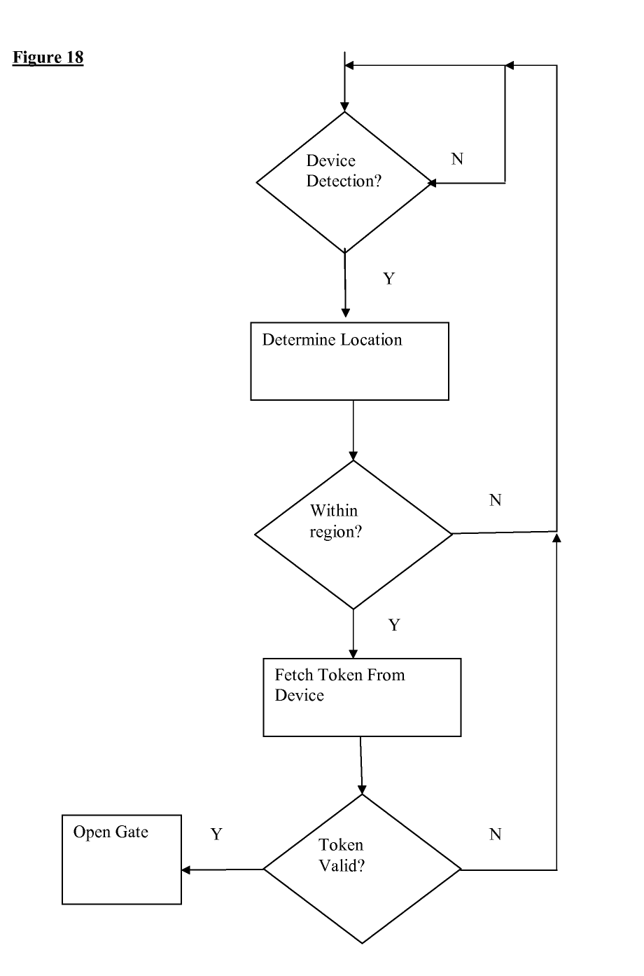

Referring to FIG. 16, the sensor antennas, 100, 101 and 102 are situated in order to be able to detect that the person's mobile device 104, is located within the turnstile, 104. Referring to FIG. 17, the antennas, 100, 101, 102 are operatively connected to a computer device, which may be a system of several computers that further transmit data, but in any case a system that can use the data received to determine the location. The computer system is operatively connected to the mobile ticketing verification system 202. That system interacts with the mobile phone, 104, in order to provide it a token or otherwise verify that the phone is associated with a valid ticket for the turnstile. Upon validation, the computer device 201, sends a command to a turnstile controller 204, which actuates the turnstile motor, 205. Referring to FIG. 18, the flow chart shows the sequence of logic that may be used in one embodiment. Practitioners of ordinary skill will recognize that the specific sequence depicted is not limiting because ticket verification could precede location confirmation, for example.

### Reusable Luggage Tags, Shipment Labels, Lanyards, Cards or Tickets

The mobile ticketing system and method may be further enhanced in connection with a physical token. For example, the system can create a single component or any combination of electronically created visually validated luggage tags, lanyards, cards (business, payment, gym membership, etc.), physical tickets, or shipping labels along with a bar code, NFC/RFID, or Bluetooth that allows for a shipment or luggage tag to constantly be reused. A luggage tag or reusable shipment label would have a unique hardware identifier associated with it, for example, an NFC, RFID, UDID, Bluetooth ID that is built into the tag itself, that would allow for it to be managed with a users account similar to how a mobile device is locked to a users account. In other words, the user's account would be bound to one or more of the identifiers that are embedded in the tag itself. The luggage tag or shipment label would contain the obvious information of the destination of the shipment or luggage, but if everything fails, since the unique identifying hardware in the tag is associated with a user account, the destination can also be determined by looking up the details of a user account. A luggage tag or reusable shipment label could also have a direct Internet connection in and of itself so that it may be searched for electronically. In the preferred embodiment, the luggage tag or reusable shipment label would be locked to a specific mobile device and user account combination that would generate a unique public/private key combination to encode and decode the details associated with the luggage tag or shipment label. Because the shipping carrier, airline, ferry operator, etc. would need to be able to decode the shipping details, they would have a public key that gives them access to read the details of the origin, destination, shipment details, prioritization, etc. Other private information would remain inaccessible. The concept of visually validated luggage tag and shipments components is also part of the system. In one embodiment, the hardware tag may itself have a modifiable visual output, which could include one or more lights or a display screen. When the tag receives a query, it can display its status. In one embodiment, luggage sorting personnel can transmit to a set of luggage a request to see a status, for example seniority. The device can either have stored within it its status code, which it then displays, or it can query a remote server for the status code by transmitting its hardware identifier, which is used by the system to match the tag to the user and from the user's account their status. This information is returned to the tag, which then displays the appropriate visual validation object. Because the validation object can be changed, it is not possible to cheat the system by having a hard-wired tag that always displays the same status indictor. The same process can be accomplished with packages that being shipped. In yet another embodiment, the tag can be loaded with the appropriate status value so that the status value can be transmitted from the tag to a local server that then validates that specific tag and then returns the visual validation display object. In addition, the system can be used to verify that someone holding that luggage is associated with the user's account. As an example embodiment, consider an airline “platinum” level traveler whose luggage has priority over other luggage being handled by the carrier. The details about the traveler's status are conveyed to the luggage tag, which in turn has a LED lighting system built into so as to indicate that the luggage is priority. The light remains activated until the system confirms pickup at the destination. Further, the luggage tag can be a certain color, animation, or light flashing combination (two quick flashes of blue over and over again as an example) to indicate that the traveler's mobile device has been detected to be proximate to the luggage tag. This permits airport security to check and verify that people have picked up their own proper luggage and not someone else's, without specifically examining traveler documents or matching luggage tag numbers. There would be no need to do further validation because the color, animation, flashing combination would indicate to the bag/ID checker that this person has already synced up the luggage tag with their mobile device and therefore they are free to go on their way. This system can be further extended the BluetoothLE/iBeacons system because luggage tags or shipment labels can become certain colors, animations, or flashing combinations based on where the luggage or shipment is at, whether it is close to a carrier iBeacon or whether it is close to the end users authorized mobile device. By use of proximity detection there is no need for the user to pull their phone out of their pocket or open an app to change the LED color combination on the luggage tag or shipment label because it automatically knows from location detection that the traveler associated with the luggage or package is sufficiently close and therefore the package is getting picked up at the destination and it can change colors.

Any of these physical tags or labels may be used in a variety of applications. For example, any physical card media that someone carries regardless of purpose (business ID, credit card, frequent visitor, gym membership, etc.) and physical tickets. The reusable physical media that integrates with the mobile device and can therefore be constantly changing based on instructions from the mobile device or other Bluetooth based data being transmitted. The concept of a constantly reusable physical tag that is integrated with a mobile device would save time, money and materials because tags are still used in a variety of circumstances ranging from luggage tags to attendee tags at venues where access is limited to the appropriate ticket type. In this embodiment, the physical media has a display format that requires it to sync up with a mobile device in order for the data information, colors, animation, light flashing, etc. to be updated, validated or modified in some form or fashion.

In yet another embodiment, the tag may be comprised of a thin touch screen or other physical input device that allows for changing the type or data of the card presented as a result of touching it. An example embodiment works as follows: the user possesses a universal card that is synchronized with their mobile device. That card can function as a number of different payment cards, IDs, frequent member card, etc. The synchronization allows for minimal encrypted information to be stored on the card. If the user goes to one store and decides to use a Mastercard™ the touch screen of the card allows the user to swipe through while presenting that credit card number into the reader. Different selections of credit card number may be presented on the same physical card. The various cards available on the card are those that are authorized for the mobile device associated with the card without the need to present the mobile device. In addition, the card could be used for things other than credit card reading, for example, where a card insertion and verification unlocks a door. In any of these cases, the physical card would be verified to be associated with the mobile device, and controlled by the mobile device, but without the mobile device itself being presented. In another embodiment, a traditional card reader can be used in combination with a fob or other device associated with the mobile device where the fob is slid through a traditional credit card reader in order for data to be captured and passed up for payment verification. In one embodiment, the system would use LoopPay™. That data process can also be used to activate the system to update the user's account.

### Operating Environment:

The system operates on one or more computers, typically one or more file servers connected to the Internet. The system is typically comprised of a central server that is connected by a data network to a user's computer. The central server may be comprised of one or more computers connected to one or more mass storage devices. A website is a central server that is connected to the Internet. The typical website has one or more files, referred to as web-pages, that are transmitted to a user's computer so that the user's computer displays an interface in dependence on the contents of the web-page file. The web-page file can contain HTML or other data that is rendered by a program operating on the user's computer. That program, referred to as a browser, permits the user to actuate virtual buttons or controls that are displayed by the browser and to input alphanumeric data. The browser operating on the user's computer then transmits values associated with the buttons or other controls and any input alphanumeric strings to the website. The website then processes these inputs, in some cases transmitting back to the user's computer additional data that is displayed by the browser. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the customer may receive from and transmit data to the central server by means of the Internet, whereby the customer accesses an account using an Internet web-browser and browser displays an interactive webpage operatively connected to the central server. The central server transmits and receives data in response to data and commands transmitted from the browser in response to the customer's actuation of the browser user interface.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (JO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A system for monitoring permission for persons to be in a location comprising:
One or more proximity detecting devices operatively connected to a computer device, said computer device adapted to determine whether a mobile device detected by the proximity detecting devices is present within a predetermined region, and in dependence on such determination, either: actuating a mechanical gate to permit entry, actuating a light, actuating a sound, actuating a vibration, updating a data record associated with the predetermined region, updating a region on a computer display corresponding to the predetermined region.

2. The system of claim 1 where the system is further comprised of a mobile ticketing validation system adapted to verify the validity of an electronic ticket associated with the mobile device that corresponds to the predetermined region and to provide the computer device a signal representing such verification in order that the actions taken in dependence on proximity detection do not occur unless the electronic ticket has been validated.
